(19) United States
(12) Patent Application Publication
(10) Pub. No.: US 2014/0257833 A1
(43) Pub. Date: Sep. 11, 2014

(54) Cloud Based System For Remote Medical Checkup And Physician Managed Biometric Data

(71) Applicant: Richard K Williams, Cupertino, CA (US)

(72) Inventor: Richard K Williams, Cupertino, CA (US)

(73) Assignee: ADVENTIVE IPBANK, Cupertino, CA (US)

(21) Appl. No.: 14/183,296

(22) Filed: Feb. 18, 2014

Related U.S. Application Data
(60) Provisional application No. 61/775,392, filed on Mar. 8, 2013.

(51) Int. Cl. G06F 19/00

(52) U.S. Cl. CPC G06F 19/3418
USPC 705/2

(57) ABSTRACT

In a remote medical checkup system, a patient's symptoms are transmitted for review to a medical service provider, the medical service provider prescribes diagnostic tests using an identified biometric sensor, the tests are performed by the patient, and the results of the tests are transmitted back to the medical service provider, all using a cloud-based server or other storage device. With this system, the tests are performed and the results reported promptly, without the patient having to schedule a visit to the office of the medical service provider.

### CROSS-REFERENCE TO RELATED APPLICATION

This application claims the priority of Provisional Application No. 61/775,392, filed Mar. 8, 2013, which is incorporated herein by reference in its entirety.

### FIELD OF INVENTION

This invention relates to the physician-managed medical data collection of biometric data including access using cloud storage.

### BACKGROUND OF INVENTION

The preponderance of new electronic medical devices able to measure and automatically access a person's health and medical condition has been steadily growing over the last few years. While these devices can be used to determine individual biometric data for a variety of medical parameters ranging from body temperature, blood pressure, and heart rate to blood sugar, blood oxygen, brain wave patterns, and even the presence of disease or pathogens in the blood, the data is largely unusable because no doctor is involved in interpreting the measurement and the person using the device is generally not a physician, and is consequently untrained in understanding what the biometric data means.

In fact, interpreting medical data without proper training cannot only cause a person to draw the wrong conclusion but can also result in a person responding irrationally or invoking panic. By misunderstanding a measurement, a person performing self-testing at home may wrongly conclude “I am very sick”, “I will soon have a heart attack”, “I caught a deadly disease”, “I have cancer”, etc. For example, testing for HIV can result in false positive results. If the test is performed at home, the person taking the test may over-react to the false data, invoking a wide range of negative emotions ranging from shame or embarrassment, to provoking severe depression or even suicide. False negative tests can be equally bad, allowing individuals needing real medical attention to lull themselves into a false sense of security, inaction, or apathy.

Uploading personal biometric data onto a website or cloud service doesn't change the risk of people playing doctor on themselves, and at their own peril and ignorance. Cloud storage of personal medical records invites other problems, including, without the proper degree of data security, the theft or illegal sale of one's own personal data or even of an individual's identity itself. So while the Internet and cloud services hold the potential for storing and managing medical data, they are not applicable in their present form in part because they lack involvement by a physician, they cannot insure security or privacy, they follow no standard protocol offering file-sharing between hospitals and clinics, and they offer no provision to prevent fraud and misrepresentation as to whose data is stored.

So for now, the medical world and the procedure for seeking professional medical attention remains largely unchanged from the way it has been for the last fifty years, generally involving scheduling a doctor's appointment before knowing what, if anything, is wrong with oneself. As shown in the flowchart of FIG. 1, the procedure today first involves a patient having an accident, experiencing trauma or pain, or recognizing they are feeling ill (step 10) whereby they call up and schedule a doctor's appointment (step 11). If they fall ill after office hours, they have to wait overnight before they are able to schedule an appointment (unless they choose to go to an emergency room in a hospital where they may be forced to sit and wait for hours while more critical cases are addressed). Regardless, at this step, the doctor or clinic knows very little of the patient's condition or symptoms and has no way to determine the medical urgency of the problem other than the patient's perceived level of discomfort.

During the time from when the patient first identifies a problem or medical need (step 10) till the patient actually visits a clinic (step 12), hours or even days may elapse. Since the doctor is unaware of the patient's true condition, there is a very real chance that the patient's condition could worsen significantly during the time they are waiting. Considering these unavoidable delays, a minor problem, if not caught early, could grow into a severe or even life threatening problem, and may ultimately and consequently result in the need for a 911 emergency response call or emergency ward visit that might have been otherwise avoided had the doctor known sooner of the patient's real condition.

For example, if a doctor realizes a patient has contracted strep throat, soon after infection (at the first signs of discomfort), the patient can be advised to go to a clinic immediately rather than wait for the onset of a high fever and severe throat pain. In some cases, e.g. in the case of an appendicitis, the ailment may advance rapidly from the first pain to reaching a potentially dangerous condition. Similar patterns exist in the hours preceding a heart attack or stroke, where had the condition been identified soon enough, permanent heart, brain or nerve damage could have been prevented altogether. A lamentation oftentimes expressed by doctors and family members after a patient suffers irreparable bodily harm, is “if only we'd had known sooner . . . ” The conventional means by which medical industry deals with illness addresses the problem too late, making matters much worse for the patient and significantly more expensive for the doctor, hospital and insurance companies.

Once a patient arrives at a clinic (step 12), the real process of determining their medical condition (step 13) occurs comprising the nurse interviewing the patient and performing some rudimentary tests (step 13a) such as checking the patients “vital signs”, i.e. blood pressure, pulse, breathing, and temperature. The doctor then reviews the preliminary evaluation, oftentimes talking to the patient in person while performing a limited re-examination and confirmation of the nurse's assessment.

If at that time the doctor finds there is a reason for concern, the doctor may order one or even a battery of tests (step 13b) oftentimes involving blood samples and lab work. The nurse then performs the required tests (step 13c) and the samples are sent to the laboratory for analysis (step 13d). Traditional lab analysis takes time, routinely requiring a lab clinician to visually inspect the sample under a microscope or to manually perform chemical lab analysis tests. Such lab tests, while generally accurate, are subject to human error. Furthermore, since the sample may comprise blood or urine, the lab clinician must take care to avoid exposure to communicable diseases or even HIV. The delay may take hours because the lab is too busy, “backed up” with prior samples and work orders, understaffed, located in a different building, or even in a different campus than the clinic. In rural areas the nearest lab may be in a city far away. The long wait further weakens the condition of the patient and in some instances may expose other patients in the same waiting room to a communicable bacterial or virulent organism. The procedure necessarily forces the patient to come out in public to visit the doctor at a time when they may in fact be most virulent and pose the greatest threat to others.

If upon reviewing the lab results (step 13e), the doctor finds the results to be non-indicative or confusing, they may order another battery of tests whereby steps 13b through 13e are repeated yet again, as many times as it takes to make a determination as to the cause of the patient's malady. Eventually, the doctor diagnoses the likely cause of the illness or condition (step 14) and then prescribes a remedy (step 15), generally pharmaceutical, to address the issue. Otherwise in mild cases, the doctor may instruct the patient to wait out the illness (do nothing), while in severe conditions the doctor may demand the patient check into a hospital immediately.

It should also be mentioned that in the clinical practice of western medicine as described, no attempt is made to naturally or holistically improve the wellness of the patient (such as boosting their immune system or stimulating the body's natural repair mechanisms) a priori, i.e. to avoid or ameliorate the condition in the first place. Instead, western medicine today concentrates on attacking the root cause of the illness while managing pain and fever through analgesics. In contrast, a growing movement of concerned citizens who believe in a more holistic and “preventative” approach complain that the present practices of doctors and insurance companies actually force people to become sick through inaction or early intervention, and that this policy decision is largely responsible for our society's spiraling medical treatment costs.

So, aside from the inconvenience, long delays, and possible hazards of delayed treatment characteristic of the present-day system, there is no potential for the doctor to practice preventative medicine, i.e. to help keep the patient from getting sick in the first place. In fact the doctor only knows a patient's condition after they are sick, and only in fact after they come in to the clinic. Annual checkups are too infrequent to catch any problem except for the gradual worsening of long-term diseases or declining health, e.g. high blood pressure, high cholesterol, low blood sugar, etc. Other than a stern warning to “eat right” or “get more exercise,” health conditions such as high blood pressure are addressed pharmaceutically ex post facto, not by preventative measures. Moreover, the drugs employed to treat a specific issue often actually cause new problems, some worse than the disease itself.

Sadly, while new electronic and biosensors capable of rapidly determining a person's medical condition continue to be introduced, a doctor has no means today to use or benefit from such innovations (except possibly to shorten the time needed during a patient's visit to the doctor's office or clinic).

What is needed is means and mechanism for a doctor to use and benefit from new biometric technology to assess a patient's condition and health before they visit their clinic (and ideally even before they become ill), to rapidly and more accurately diagnose a medical condition of a patient, to shorten the time needed for office visits, and to promote wellness to prevent the onset of disease. What is also needed is a means to get the doctor involved in the home biometric evaluation of a patient in a convenient, frequent, and secure manner to discourage people from making unqualified medical decisions about themselves, and to encourage improved health through proactive monitoring and early intervention at the onset of illness.

### SUMMARY OF THE INVENTION

The procedure of this invention uses a cloud database to allow a patient to notify a doctor or other medical service provider of a problem, to have diagnostic tests performed, and to receive a prescription or other recommendation from the medical service provider, all without making a visit to the doctor's office. In some cases, the doctor may ask the patient to make a visit to his or her office, but only after the diagnostic tests have been performed and it has been decided that such a visit is necessary.

Initially, the patient enters information concerning his or her problem in a computer. The information is transmitted to a server or other storage device in the “cloud,” where it ‘is stored in an eCheckup test’ file (eCTF), which is specific to the particular inquiry. The eCTF contains information such as patient identity information, patient medical history information, a description of the biometric senor to be used in the test, calibration information relating to the biometric sensor, test measurement setup information, and the resulting measurement data obtained from the test. The patient's inquiry is transmitted to a computer in the doctor's office, where it is reviewed by the doctor or a member of his or her staff. Based on this information, a request for a particular diagnostic test or examination is transmitted back to the eCTF together with an identification of the biometric sensor to be used in the test and, if necessary, information for calibrating the biometric sensor.

The patient then performs the indicated biometric test(s) and the test results are uploaded to the eCTF. The biometric sensor used for the test could be electrical, chemical, biochemical, bio-organic, physical, optical or acoustic, for example. After reviewing the test results, the doctor prescribes the treatment and so informs the patient, typically by telephone. Alternatively, the prescription could be made known to the patient through another form of communication, such as email.

This system allows a medical service provider to review the patient's problem promptly, without waiting days or weeks for an office appointment. This is of particular importance where immediate treatment is necessary and where a delay of even a day or two could allow the patient's condition to deteriorate, making the treatment significantly more difficult and/or expensive and negatively affecting the prognosis for recovery.

This invention will be understood more fully by reference to the following more detailed description and drawings.

### BRIEF DESCRIPTION OF THE DRAWINGS

In the following drawings, like elements are identified by the same reference number.

FIG. 1 is a flowchart illustrating the procedure of a conventional medical checkup.

FIG. 2 is a general diagram of the infrastructure of an eCheckup according to the invention.

FIG. 3 is a flowchart illustrating the process of an eCheckup according to the invention.

FIG. 4 is a diagram of the core biometric sensors used in an eCheckup according to the invention.

FIG. 5 is a block diagram of a system for remote physician control of the eCheckup biometric sensors.

FIG. 6 is a table showing the various medical conditions that can be monitored using the biometric measurement devices in an eCheckup system.

FIG. 7A illustrates examples of electrical biometric proximity sensors and the organs they are capable of measuring.

FIG. 7B illustrates examples of physical biometric sensors and the physical parameters they are capable of measuring.

FIG. 8 illustrates examples of physical biometric sensors and the physical parameters they are capable of measuring.

FIG. 9 illustrates examples of acoustic biometric sensors and the organs they are capable of measuring.

FIG. 10 illustrates examples of a heterogeneous sensor array to monitor a fluid or tissue sample.

FIG. 11 illustrates examples of wearable biometric sensors.

### DESCRIPTION OF THE INVENTION

In order to improve the quality of health of individuals and of society as a whole, doctors and the medical industry in general should have access to key information about their patients condition or progress in a frequent and timely manner. Today, frequent visits by a patient to a doctor's office or local clinic are undesirable for a number of reasons, including the difficulty they create in matching the visit to one's personal schedule, the inconvenience of travel to the clinic, loss of productivity resulting from time away from work and family duties, and their relatively high cost. Because of these and other reasons, doctor office visits are necessarily infrequent and generally do not occur in a timely manner, especially because finding a time to meet one's doctor when both are doctor and patient are free can be difficult.

Instead, the efficiency of the entire process of medical checkups can be improved substantially if biometric data about a patient's condition can, at least in part, be obtained by the patient while at home, and then uploaded to a secure database in the cloud, using secure communication over the Internet. Information to facilitate such electronically implemented medical checkups, referred to herein as “eCheckups”, must necessarily flow bidirectionally from the physician to the patient as to what tests need to be performed (and at what test conditions), and conversely from the patient to the physician in the form of the measured test results. Whether the test conditions are specified by the physician (such as performing a test using biosensors) or are standardized and fully automated (such as blood pressure measurements) bidirectional communication between the software client and the cloud is necessarily bidirectional to insure that the test and the patient's file are properly linked and verified for the purposes of accuracy, security, and privacy.

Adapting the Internet as the communications backbone and combining it with an innovative medical cloud database and flexible interface protocol for sensor input forms the basis of the eCheckup methodology disclosed herein. As disclosed, the cloud database described addresses the issues of merging data (i.e. instructions and measurements) from both physician and patient, and securely storing this data for convenient but secure access. Notably, the software ecosphere for capturing, organizing and controlling such data and the associated hardware designed to be compliant with such a system and its protocols do not presently exist and are thereby disclosed herein as embodiments of this invention.

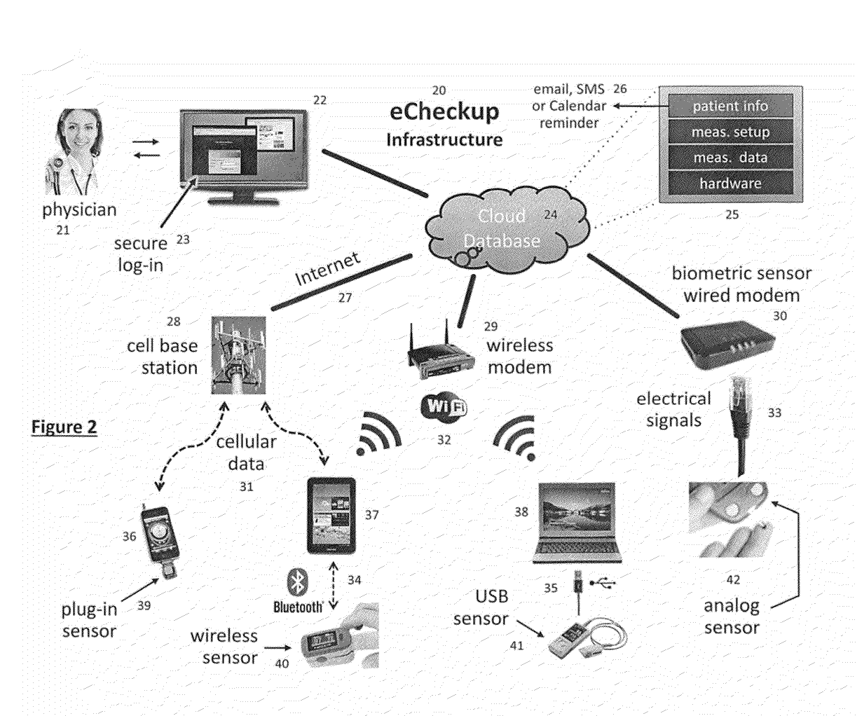

Shown in FIG. 2, this eCheckup infrastructure 20 comprises a number of hardware and software elements connecting patient and doctor in a virtual, web based manner. (It should clarified that any of the public graphical images shown of any hardware in this application (e.g., sensor, computer or communication device) is not meant to represent a specific or pre-existing device, to represent any particular company or product existing today, to infer any particular company's products will or can be eCheckup compliant, or to be represented as an endorsement of the eCheckup methodology and architecture defined herein. The graphical images of hardware included herein are used solely to assist in illustrating the elements needed to realize eCheckup infrastructure 20 and to aid in describing its operation.)

As shown, a cloud database 24 comprises files of patients' medical and test histories, including individual and specific eCheckup test files 25 containing information used to facilitate the eCheckup methodology disclosed herein. The concept of a cloud database, also referred to as “the cloud” in the public press, refers to as a database accessed through Internet connectivity by one or any number of clients. The cloud database may physically reside in one or any number of computer servers or server farms potentially with access to vast amounts of non-volatile memory in which to store the data.

In general, the cloud database is accessed through a World Wide Web address or “URL” without the user or client necessarily knowing where the data physically resides or even what database service provider is servicing the account at any given time. Because the physicality of the data is ambiguous and diffuse, the term “cloud” was adopted and is now common English “tech” vernacular. In some cases, large corporations, for example insurance companies or enterprise service providers, may maintain their own server farms to store the database. Despite owning the hardware, the term cloud is still generally applicable to any database accessible over the Internet. While a medical database may also be stored in a private server accessible only through a privately owned intranet, and not through the Internet, such a database owner loses the advantage of interacting with smaller clinics or sharing data with hospitals outside its private intranet.

Again referring to FIG. 2, each eCheckup test file 25 represents the information for a specific eCheckup test comprising patient information, a description of the hardware being used by the test (including equipment calibration if needed), test measurement setup information, and the resulting measurement data taken by the test. Each test performed has a corresponding eCheckup test file (eCTF) 25. If more than one test is performed, the eCheckup test, or more accurately the battery of eCheckup tests, will comprise multiple eCheckup test files (eCTF's). A doctor may also instruct a patient to take repeated tests for an extended duration (e.g. one a day for a week, once a week for a month, etc.). These instructions may also be uploaded into the patient information register of eCTF 25 and used to automatically generate calendar events and to trigger email or SMS (simple message service) text message reminders to the patient.

Patient information, including secure data describing the person's name, address, hospital account number, password, and PIN code, is collectively employed to insure that the data collected is sent to the right account describing a specific patient. Identification and password security measures are included to prevent someone from “faking” the test to upload bogus data possibly from the wrong person, and to prevent fake eCheckup uploads from being used to facilitate insurance fraud, false insurance claims, or identity theft. The test procedure also optionally includes a video camera recording (e.g. as a mpeg file or a picture snapshot) of the patient performing the test, providing a means for the clinic to visually confirm the uploaded data truly matches the patient's identification. Patient information is uploaded at the beginning of each test as part of the same data packet to insure no comingling of data among different patients' data in the cloud.

The biometric sensing “hardware” file portion of eCTF 25 includes an identification of the specific device used for the test, including a unique code for each piece of equipment comprising manufacturer, make, and model; a description of its control parameters, e.g. start/stop, pressure, temperature, light frequency, etc., as well as the default setup parametric values of the biometric sensing hardware. The file may include the description of several physician-approved devices for performing a test, allowing the user to select the one they have available from the list. Once selected, the appropriate settings are loaded into the hardware and the measurement conditions are copied into the measurement setup register.

In some cases, the hardware may require calibration before operation. In such instances the hardware calibration sequence and user instruction file (shown on a display) is included in the hardware file. Before a measurement can be performed, the user may be instructed to perform some simple steps to calibrate the hardware. For example, a chemical test may require first dropping deionized water onto the sensor to calibrate the pH of the test condition. Measurements taken during the calibration sequence are loaded into the hardware file as a calibration table. The calibration is used to correct the measured data for accuracy to set standards.

The “measurement setup” defines the test condition for that particular eCheckup test in any device where the specific operating condition control parameters are adjustable. For adjustable test devices, the operating condition control parameters have a default value that may be changed only by the physician requesting the eCheckup, but generally not by the patient. In some cases the default conditions may be automatically adjusted or overwritten for patient specific information. For example, the measurement condition may be adjusted for a patient's weight, age, or blood pressure. This personal data may be extracted from the patient info profile, entered manually just prior to the test, or loaded from other eCheckup test data taken previously, ideally just prior to the test.

During the actual test, measurement data collected is temporarily stored in a data buffer. At the conclusion of the test the data is uploaded from the data buffer into the measured data register of eCTF 25. If the upload is not available at that time ideally the data is stored in the test device and uploaded as soon as the network becomes available.

Various eCheckup test devices are connected to cloud database 24 through commercially available hardware infrastructure comprising wire-line and wireless links. Cloud database 24 may connect to users through fiber, cable and copper comprising high-speed networks carrying data via the Internet 27 to a cellular base station 28, a wireless modem router 29, or a wired modem 30. Wired modem 30 may also include hardware and driver firmware specifically designed for driving and measuring biometric sensors. The data flow is bidirectional, with programs and test settings and setup conditions from the responsible physician downloaded into an eCheckup device and patient information and data from the sensors uploaded to the cloud through the communication link.

Cellular data 31 broadcasted and received by cellular base station 28 may be transceived by any cellular modem, typically using 3G (HSDPA and BUPA), or by 4G or 4G/LTE protocols and hardware. The user's actual RF link hardware for cellular data 31 may comprise a mobile phone or smartphone 36, a tablet computer 37, or wireless cellular USB modem for a notebook computer 38. The cellular data 31 in eCheckup infrastructure 20 flows bidirectionally. Biometric sensors may comprise a plug-in sensor 39, wherein the software for driving plug-in sensor 39 takes the form of an app in mobile phone or smartphone 36, or an independent sensor unit such as wireless sensor 40 connected to tablet computer 37 through a Bluetooth wireless link 34. While plug-in sensor 39 may be powered by the device it is plugged into, e.g. by mobile phone or smartphone 39, independent wireless sensor 40 may be portable and self contained, where some data processing may be performed in an app running on tablet computer 37 but the driver functions, test data collection and signal processing are embedded in wireless sensor 40. Power for wireless sensor 40 may comprise single-use or rechargeable batteries.

Data from wireless modem router 29 may be carried by WiFi signal 32 to mobile phone or smart phone 36, or to tablet computer 37 or notebook computer 38. WiFi may comprise any current or future standard including 801.11g or 802.11n and newer emerging standards. WiFi signal 32 for eCheckup infrastructure 20 flows bidirectionally. In such a case, the sensor may comprise a wired connected device such as USB sensor 41, connected via digital port and USB connector 35 or alternatively through other wired protocols such as Thunderbolt, Firewire, etc. Since all modern interface connector standards now include a protected power-connected pin, USB sensor 41 derives its power from its USB port as supplied by notebook computer 38. Notebook computer 38 also performs signal processing and sensor driver algorithms controlled by an application program running on notebook computer 38.

In all the wirelessly linked devices such as notebook computer 38, tablet computer 37 and mobile phone or smartphone 36, the communication device actually carries the data, converting it into wireless protocol in accordance with cellular data protocol 31 or WiFi protocol 32. In the case of biometric sensor wired modem 30, however, the modem box itself can also integrate the drive electronics for any number of sensors having digital or even analog connections such as analog sensor 42 connected through electrical connector 33. Unlike USB connector 35, electrical connector 33 can constitute any proprietary format.

As a practical manner, small biometric sensors used frequently for checking heart rate, blood sugar, and the like are likely to comprise small single-function consumer devices designed for portability and convenience. Such biometric sensors are likely to communicate wirelessly through mobile phone or smartphone 36 and tablet computer 38. Less frequently tested biometrics and tests utilizing more bulky sensors such as blood pressure cuffs have no compelling need to be ultra portable so that less portable and wired solutions such as notebook computer 38 and biometric sensor wired modem 30 are more acceptable. The value of a multi-sensor system is particularly useful to perform a complete checkup without the need for going to a doctors office or clinic.

As shown in FIG. 2, biometric sensors 39-42 may be connected to cloud database 34 using existing technology in order to realize eCheckup infrastructure 20. A physician is then enabled to interact with patients remotely using web-connected computer 22 and secure log-in window 23 to improve overall health care efficiency using cloud-based connectivity. As disclosed herein, the data structure of eCTF 25 must be sufficiently flexible and robust as to accommodate a wide range of tests and biometric sensors but sufficiently standardized that a universal “standardized” protocol assures the commercial developers of biometric sensors that their products, once developed and commercialized, are eCheckup compatible and compliant.

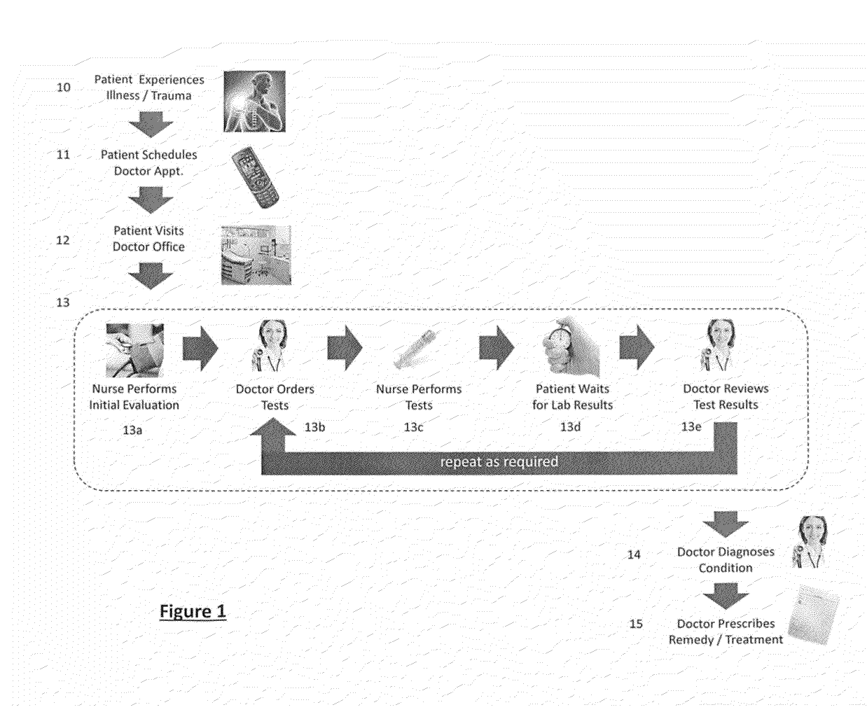

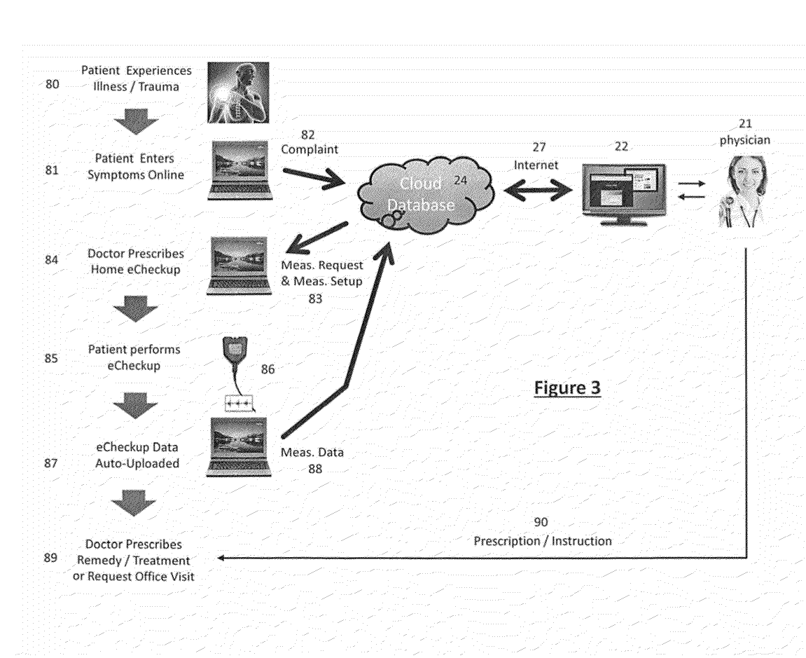

Unlike the long delays a patient is likely to experience before appropriate medical treatment can be administered in the traditional sequence of events described in FIG. 1, eCheckup is able to greatly shorten the entire process because it delivers timely and relevant information to the physician and clinic so they can make better informed decisions as to urgency of the patient's condition. The brevity and simplicity of the eCheckup process is illustrated in FIG. 3, illustrating the physician or clinic receives a complaint 82 immediately after a patient experiences discomfort (step 80) and describes their symptoms through an online portal 81.

The complaint is registered in a cloud database 24 where a clinic, attending physician 21, or other medical service provider has access to the complaint through an Internet 27 connected secure window 22. Ideally, the initial review of the complaint may be performed by an eCheckup service provider working in the same medical group, or alternatively by a service-for-hire eCheckup certified team of medical technicians. The response to the patient, facilitated through cloud database 24 is a prescription to perform specific home eCheckup tests (step 84) including the measurement request and measurement setup 83 securely downloaded into the patient's phone or computer from cloud database 24 over the Internet.

Assuming for a moment that a patient owns the necessary eCheckup compliant hardware and biometric sensors 86, the patient then perform one or more eCheckup tests (step 85), as instructed, whereby the measured data 88 is automatically uploaded from the client software 87 running on the patient's computer or phone to the cloud database 24.

Upon receiving the data 88 and reviewing it on the cloud database 24, the physician 21 or other medical technician may prescribe a remedy or treatment (including either over the counter or prescription medicine), may schedule a doctor's appointment, or may ask the patient to visit the emergency room. In extreme cases, the physician may immediately schedule a 911 emergency response. If the eCheckup test identifies the presence of a severely dangerous contagion such as SARs, smallpox, Ebola, or a bioterrorist weapon where bio-containment is demanded, the physician 21 may contact the authorities or the CDC (Center for Disease Control) and immediately dispatch a Has-mat/Bio-containment team to the site.

In any case, by performing the doctor ordered set of eCheckup tests at home, the entire process of identifying the severity of a patient's condition and prescribing the proper degree and level of emergency response is significantly shortened, potentially from days to hours or even minutes. In some cases, the time saved may save a patient's life. In cases of disease outbreaks or bio-terrorism attacks, the process may save hundreds or thousands of lives by limiting the exposure of others.

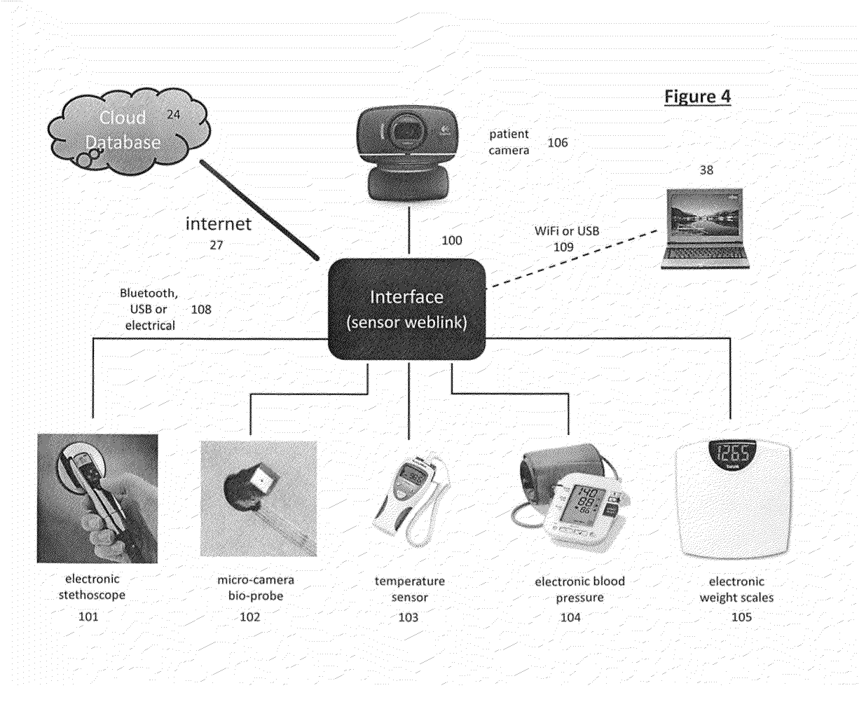

Deploying eCheckup to consumers for home use involves an initial investment in the biometric sensors needed to remotely tell a physician about a patient's condition. The most important basic conditions as shown in FIG. 4, called a patient's vital signs, comprise body temperature checked by infrared thermometer temperature sensor 103 along with pulse rate and blood pressure checked by an electronic blood pressure cuff or sleeve 104. Alternatively, a patient's heart condition may also be checked by a dedicated pulse and heart rhythm sensor (not shown). It is also beneficial to measure a patient's weight using eCheckup-compatible electronic weight scales 105, check their breathing and lung condition with an eCheckup-compatible electronic stethoscope 101, and employ a micro-camera bio-probe 102 to visually check a patient's eyes, ears, nose, and throat.

Performing a physician-directed lung and heart eCheckup, a patient is instructed to position stethoscope 101 over a number of places across the chest or hack and breathe deeply to capture sounds from the lungs and heart. Stethoscopic examination of the heart and lungs is important for determine if the lungs are clear or retaining fluid, a condition indicative of infection (e.g. pneumonia) or of cardiopulmonary duress (often as a precursor to a heart attack). The stethoscope may also capture wheezing in the lungs, another indicator of asthma or other breathing problems, or reveal a heart murmur, suggesting cardiovascular disease. Stethoscopic examination is generally considered a key evaluation in determining a patient's general condition, and therefore is an indispensible element to realizing eCheckup as a credible methodology in a timely first-response health assessment of a patient.

During the lung and heart eCheckup examination, a video camera 106 captures the patient's actions on video, allowing the doctor or nurse reviewing the test to see where the patient measured while listening to the audio signal detected from stethoscope 101. The video image may be stored as an MPEG file while the audio may be recorded in an MP3 or other standard audio file. Alternatively, the sound may optionally be written into the audio track of the MPEG video file. Optionally, for patient privacy reasons, the video image during this (or any semi-nude) test may be electronically modified into an animated image of the patient obscuring body details while still clearly identifying to the physician where the stethoscope or biometric sensor was located during a particular audio sample or test.

For checking the eyes, ears, nose and throat, the patient may be instructed to use micro-camera bio-probe 102. In its application the patient will be instructed first to look closely at their eyes, then to insert the probe into their mouth, and then carefully to place the probe into their ears and nose. During the micro-camera examination, a video image captures pictures or video of the eyes, the back of the throat, and of the sinus cavities offering visual evidence of infection, irritation, or swelling. The images are captured in JPG or MPEG file formats and uploaded to the cloud.

While sensors 101 to 105 can all be independently linked to the cloud to facilitate eCheckup, it is convenient and economically advantageous to integrate the sensors into a single unit acting as a sensor weblink interface 100. Interface 100 comprises a wired modem link to cloud database 24 through Internet 27 while capturing data from biometric sensors 101-105. The connections 108 from the sensor weblink interface 100 to the biometric sensors 101 to 105 may comprise an RF link such as Bluetooth, a standardized digital connection such as USB, or an electrical connection. While Bluetooth or wireless RF links afford the greatest mobility and freedom of movement, their use requires the biometric sensor to be battery powered. A standardized digital interface such as USB limits the patient's freedom of movement during testing but has the advantage of providing power to the sensor. In either case, whether a digital connector or an RF link is employed, signal processing and analysis must mostly be performed inside the biometric sensor.

In the event that the connection is electrical, the actual driving circuitry, signal processing and power can be integrated within interface 100, and a “dumb” biometric sensor can be employed. Partitioning the overall system to integrate greater intelligence into interface 100, while increasing its role in the eCheckup methodology, renders the unit more sensor-specific and less general purpose. Alternatively, by establishing a standardized connector for biometric sensors, interface 100 can operate with any number of compatible biometric sensors.

In combination with biometric sensors 101 to 105, interface 100 provides a simple basic eCheckup “kit” for assessing a patient's condition and checking their vital signs and uploading the information to cloud database 24 through Internet 27. Camera 106 is used to confirm the patient's identity at the onset of the test and as described to confirm the location of a stethoscope or other biometric probe as it the data is being taken. Interface 100 may comprise a dedicated controller with display and keypad, or a full touchscreen graphical user interface (GUI). Alternatively, notebook computer 38 connected by a WiFi or USB link 109 to interface 100 may provide the GUI, display, keypad and even patient camera 106 eliminating the need to integrate them into interface 100. In the architecture shown, the sensor weblink interface 100 includes a wired or wireless link to Internet 27, meaning data passes from the sensors 101 to 105 into interface 100 and then directly from interface 100 to the internet 27 and cloud database 24, without the measured data ever passing through notebook computer 38. In this embodiment of the invention, notebook computer 38 acts as a control terminal, not as the communications link or signal processor. As such, interface 100 can be custom-designed to include power supplies, sensor drivers and bias supplies, A/D converters and sensitive instrumentation amplifiers, mixed with standard digital interfaces such as Bluetooth, WiFi, USB, Thunderbolt, etc. as desired and in any combination.

In an alternative embodiment the measurements taken by biometric sensors 101 to 105 are processed by interface 100 and this data is passed digitally to notebook computer 38, which provides the WiFi, Ethernet, satellite, or fiber link to the Internet and ultimately cloud database 24. This approach enables easier signal post-processing by running dedicated application programs on notebook computer 38 and reduces the digital computational demands on interface 100, allowing its role to remain focused on driving sensors and performing signal processing on sensor signals.

In yet a third embodiment of this invention the function of interface 100 is performed entirely in notebook computer 38, i.e. interface 100 is realized using notebook computer 38 running dedicated software. The disadvantage of completely replacing interface 100 with a computer is that dedicated analog circuitry is not included in any commonly available computer or notebook. This implementation means biometric sensors 101 through 105 must be “smart” sensors with their own internal drive circuitry, signal processing, calibration circuitry and digital communication interface.

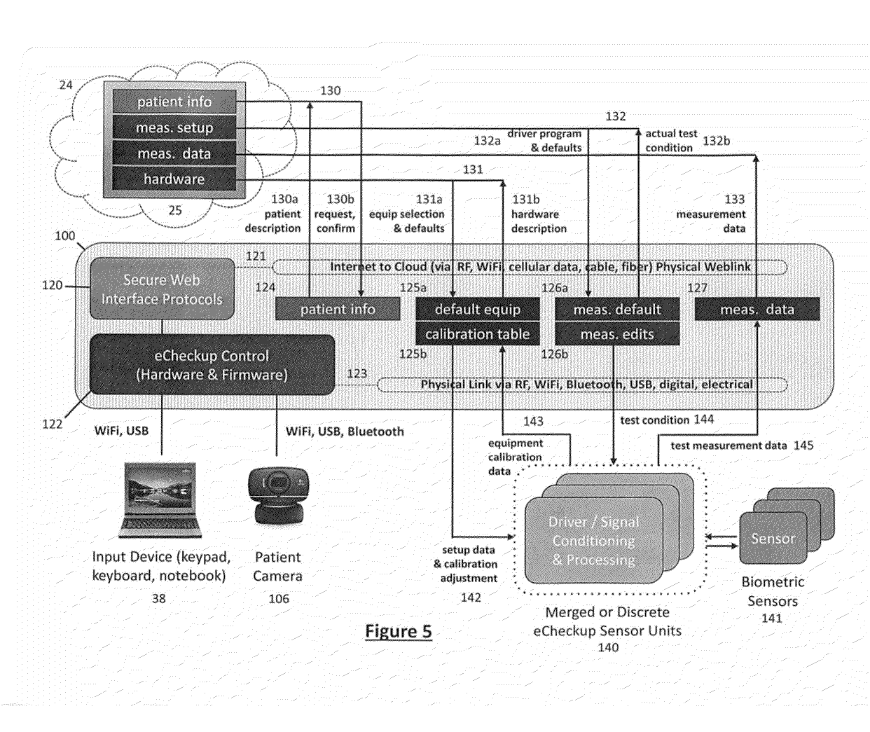

Regardless of the physical partitioning of the system, the control of a measurement and the processing of the biometric sensor signal into data that can be uploaded into the medical cloud 24 and eCheckup test files (eCTFs) 25 in accordance with the disclosed eCheckup methodology can be visualized as an information flow shown in FIG. 5. In this schematic and block diagram, the function of interface 100 is represented by a number of control blocks, data registers, and interfaces. As stated previously, these elements may be physical—comprising dedicated hardware; they may be virtual elements—functions implemented as data structures in a computer program; or they may represent some intermediary combination of the two, i.e. firmware controlled hardware.

As shown, interface 100 performs a number of functions illustrated as secure web interface protocol blocks 120, and eCheckup control block 122, implementing eCheckup control of both hardware and firmware. Specifically, secure web interface protocol block 120 controls the data handshaking and Internet-to-cloud physical weblink 121 connecting the data registers 124-127 to the cloud 24. The Internet-to-cloud physical weblink 121 may comprise any wired or wireless communication protocol. Wireless links may comprise cellular data such as 3G, HSDPA, HSUPA, 4G and 4G/LTE connections, or WiFi. Wired links may include Ethernet, DSL, cable, or optical fiber. The connection likely may involve a serial combination of a wireless link such as WiFi connected to a wireless modem router connected to coaxial cable or optical fiber links to the Internet. Collectively the weblink data 130 through 133 carried between cloud 24 and sensor interface 100 comprises patient information, handshaking confirmation, equipment related information and measurement related information.

The eCheckup control block 122 interfaces to input device 38 and patient camera 106 while controlling the physical link 123 between data registers 124-127 and eCheckup sensor-units 140 driving biometric sensors 141. The physical link may comprise a wireless or wired link. Wireless communication may be achieved by a number of RF protocols such WiFi, Bluetooth, or proprietary protocols. Wired connections may comprise electrical connections mixing any combination of analog and digital signals, as well as electrical power. Digital signals may comprise serial or parallel data formats or follow industry standard protocols such as Universal Serial Bus (USB). The data carried between the eCheckup sensor units 140 and sensor interface 100 includes setup and calibration adjustment data 142, equipment calibration data 143, test condition data 144 and test measurement data 145.

In operation, the patient or alternatively their physician updates the patient information data file in eCTF 25 in cloud 24, to describe a patient's condition. The patient information file is synchronized with the patient information register 124 within sensor interface 100 using a data transfer 130 comprising a request for information 130b generated by eCTF 25. In response, patient information entered into patient information register 124 through input device 38 along with a video capture file of the patient taken through patient camera 106 is then transferred through data transfer 130a to the patient information file in eCTF 25. If a match between the intended patient and the operator of sensor interface 100 is verified, then data transfer 130b confirms the test is approved to proceed and passes the necessary eCheckup instructions to sensor interface 100. Confirmation may involve a patient's name and birthdate, address, government identification number, patient account number or possibly a PIN code or password. If greater security is needed, a system generated PIN emailed or text messaged to the patient, or biometric identification such as electronic fingerprint identification may also be used.

While affirmative patient verification can also be made through patient camera 106, in most cases the video file will not be used to approve a test a priori, but may be used after a test is completed to verify that the person tested was in fact the correct patient, especially in the event of unexpected eCheckup test results. The ability to reconfirm that the test was properly performed on the right patient ex post facto is especially important in cases of malpractice litigation, where an adverse party may assert that the attending physician used the wrong data in formulating their diagnosis and prescription.

Upon confirmation, eCheckup instructions are sent from eCTF 25 to default equipment data register 125a and measurement default register 126a. The default equipment register 125a holds the data describing the operation and setup of one or any number of devices and manufacturers qualified to perform the eCheckup tests. If the connected sensor is one of the qualified devices then the default equipment settings 131a are transferred into register 125a. Alternatively, the setup conditions for every qualified biometric sensor may be all downloaded at one time from the hardware register in eCTF 25 into default equipment register 125a and sensor interface 100 may simply select the appropriate data file consistent with whatever sensor unit 140 is attached to it.

In conjunction with default equipment register 125a, during setup an associated register 125b for storing an equipment setup calibration table is initialized to a null set condition. In the null set condition, the setup data in default equipment register 125a will be passed using data transfer 142 unchanged into eCheckup sensor unit 140 retaining the exact default conditions originally downloaded from cloud 24. Such a case arises whenever sensor unit 140 requires no calibration to operate properly, meaning the default setup values and bias conditions are not adjusted either up or down from their initial value.

Mathematically, a null data set in calibration table register 125b means that for any parameter using a multiplicative adjustment during calibration, the specific multiplier in calibration table 125b is set to one, i.e. unity, so that the outputted setup parameter xₒᵤₜ retains its default value whereby xₒᵤₜ=1·x_{default}. Conversely, for any parameter using an additive adjustment during calibration, the specific multiplier in calibration table register 125b is set to zero so that the outputted setup parameter xₒᵤₜ retains its default value because xₒᵤₜ=0±x_{default}. In this manner the initial null set data contained within calibration table register 125b do not affect the bias or sensor driver conditions in sensor unit 140.

Once the default setup conditions are loaded into sensor unit 140 by data transfer 142, in a preferred embodiment the data is reread by sensor interface 100 using data transfer 143 to confirm the proper driving conditions have been successfully loaded into the sensor unit's driver circuitry. This one time “handshake” confirms that that the sensor unit 140 and the sensor interface and properly communicating and the entire system and biometric sensor are set up correctly, helping ensure accuracy, data integrity, and safety in the eCheckup procedure.

As disclosed, sensor interface 100 is then able to connect to, communicate with, and set up sensor units 140 by downloading specific driving conditions into sensor units 140 via data transfer 142 and confirming the conditions by reading back the stored settings from the sensor units 140 using data transfer 143. If multiple sensors are employed, this procedure is repeated for each of them. An example of such a handshake setup of a biometric sensor could for example be to set the pressure range of a dynamometer or lung pressure to match the size and weight of a patient. If the sensor's counterforce is too strong, a patient might not be able to move the sensor at all, i.e. no signal. If the counterforce is too weak the patient may move the sensor to full scale too easily so that the actual force is “out of range” for the measurement.

In some cases, sensor unit 140 may contain a fixed algorithm without the need for any setup data to be loaded from sensor interface 100. In such cases, data transfer 142 can be skipped. If there are no settings to be read back, then data transfer 143 can also be skipped. One example where no setup information is required is a weight scale or an infrared thermometer. In some instances, no setup data is required but the sensor may go through a self-calibration procedure. In such cases, the final value of the bias or operating conditions for sensor unit 140 is transferred to calibration table 125b by data transfer 143 in order to store and recover the test conditions at a later data should it become important.

In some instances however, equipment calibration is needed before a test can be performed. In such cases, sensor unit 140 sequentially adjusts its settings in an attempt to bias the sensor at the targeted condition and in accordance with patient information or ambient conditions, e.g. temperature or humidity. Examples requiring initial calibration may include biosensors or chemical sensors. The calibration sequence involves biasing the sensor to a known condition, measuring a result, comparing it to the expected result, changing the bias condition and repeating the test until the expected result is achieved. This change in the operating or bias condition is recorded as a multiplier or error term stored in calibration table 125a and modifying the default setting stored in default equipment register 125a.

The calibration sequence involves repeatedly sending new bias condition via data transfer 142, measuring the result and sending the data back via data transfer 143, updating calibration table 125b and repeating until the result stabilizes at the expected level. For example a biosensor may lose sensitivity due to oxidation of the sensor electrodes during aging. In calibration, the analog gain of the input amplifier is increased until the proper signal magnitude is reached using a known sample or reference material. Calibration is dissimilar from a biometric test because the calibration must be performed with a known reference sample. For example, a pH sensor will be calibrated to a pH of 7 using deionized water, but for the test a fluid sample is used. Once calibrated, the sensor units are ready to perform the required eCheckup tests.

After the equipment and biometric sensors are setup and calibrated, the measurement setup is downloaded from eCTF 25 in cloud 24 to a measurement default register 126a of sensor interface 101 via weblink data 132a. Measurement default register 126a describes the tests to be performed and possibly the test conditions and even the software to analyze or interpret the results. In some cases the doctor or the patient may elect or even be requested to make certain changes to the measurement default conditions. For example an array of chemical sensors might in its default test procedure simultaneously test for the presence of 12 different chemicals but the doctor may only be interested in the patient's calcium and potassium levels. If so, the physician might disable the unnecessary tests to speed the analysis. The physician's changes located in the measurement setup file of eCTF 25 are copied from cloud 24 via weblink data 132a into a measurement edits register 126b of sensor interface 100. Sensor interface 100 may algorithmically change the test conditions based on previous biometric test results. For example, the tests to be performed may change based on the results of blood pressure or body temperature readings performed at the start of the eCheckup. These changes are also recorded in measurement edits register 126b of sensor interface 100.

Regardless of how or why changes in measurements or measurement conditions occurred this information is stored in measurement edits register 126b. Combining the data from measurement edits register 126b with the default test measurements stored in measurement default register 126a, sensor interface 100 loads the test conditions into sensor units 140 via data transfer 144 and likewise uploads the final test conditions, the actual test performed, to the measurement setup file in eCTF 25 via weblink data 132b.

The driver circuitry in sensor units 140 then drives biometric sensors 141, capturing the data and loading it into a measurement data register 127 within sensor interface 100 via a test measurement data transfer 145. This data set comprising the biometric sensor test results are then transferred to eCTF file 25 within cloud 24 via weblink data 133.

While data from sensor interface 100 can be transferred to cloud 24 and eCTF 25 sequentially and serially, in practice it is preferable to upload all the data from registers 124-127 to eCTF 25 at one time. After the tests are complete and the data is uploaded to cloud 24, the eCTF 25 data files include all the test results and test conditions for the physician to review at their convenience. The patient may or may not get to see the results of the tests immediately depending on the physician's preferences. For example, for basic tests like blood pressure or body temperature there is no reason not to share the information with the patient immediately since they could garner the same information using non-eCheckup compatible test devices. On the other hand, for sophisticated blood or urine tests capable of identifying a severe disease, contagion, or dangerous condition it may be preferable to send the information only to the physician and let them discuss the matter with the patient.

The eCheckup methodology as disclosed accommodates collecting and capturing an unlimited range of biometric sensor data and facilitating efficient and secure communication between a patient performing eCheckup at home and their physician, even before the patient visits the physician's clinic or office. In fact, eCheckup is valuable in helping make early diagnosis of disease, offering many of the advantages of a country doctor's house call, without forcing doctor or patient to travel until it is deemed necessary.

As a methodology, eCheckup can support collecting any type of biometric data (other than those using dangerous or large machines such as CAT scans and radiology). As electronic biometric sensor technology evolves, the value and importance of defining a prescribed procedure for remotely collecting and managing biometric data will become increasingly important.

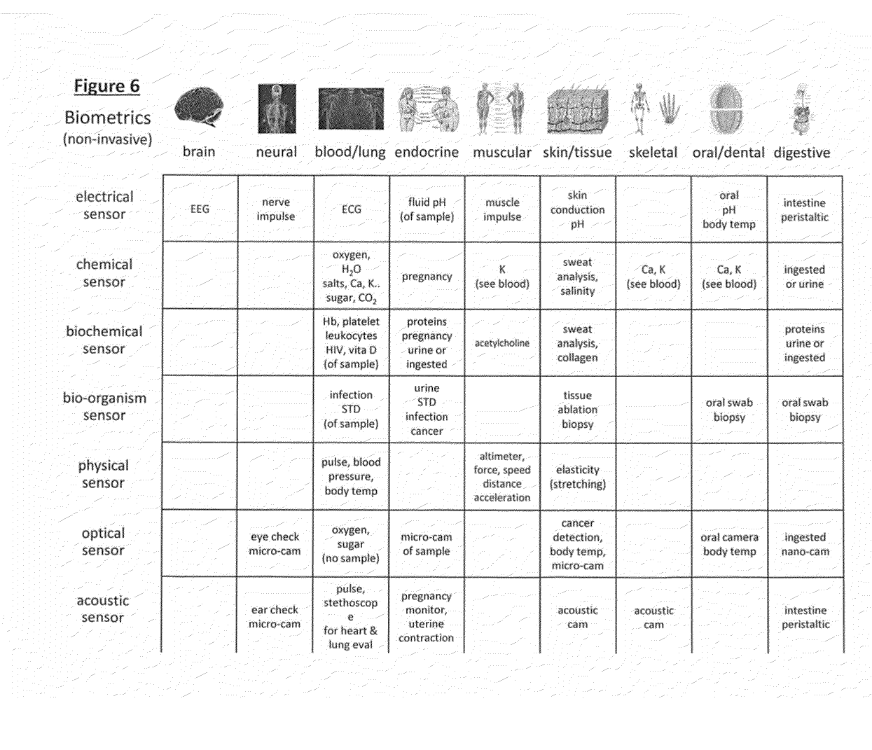

FIG. 6 is a table illustrating the large array for non-invasive biometric data that is or will be available using electronic biometric sensor technology. In the illustration, each row represents a type or class of biometric sensor and each column represents an organ or physiological system in the human body. The cells defining the row-column intersection describe the type of data the particular class of sensors can measure related to that specific organ or body system.

The sensors are divided into the types of information they measure, or the physical mechanism of their measurement, specifically electrical sensors, chemical sensors, biochemical sensors, bio-organism sensors, physical sensors, optical sensors, and acoustic sensors. X-ray sensors are not included because they involve hazardous material not available to consumers and implantable sensors are similarly not shown because they involve invasive procedures. The body's organs and systems include the brain, the nervous system, the circulatory and respiratory systems (collectively shown as blood/lung), the endocrine system including hormonal glands and sex organs, muscular structure including soft tissue, ligaments and tendons, skeletal structure including hands and fingers, oral/dental including teeth and the jaw, and the digestive system including the stomach, intestines, bladder, and kidneys.

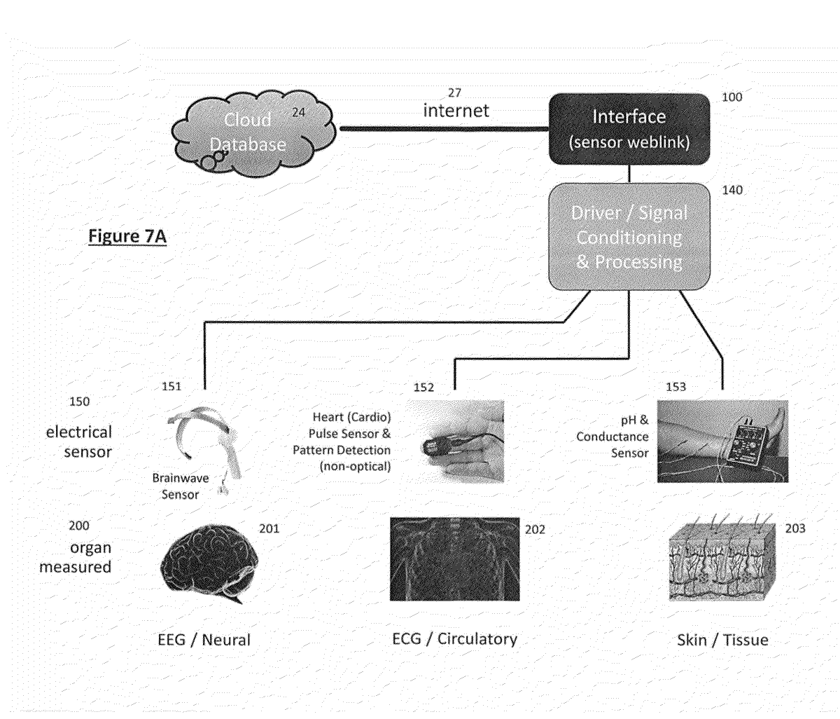

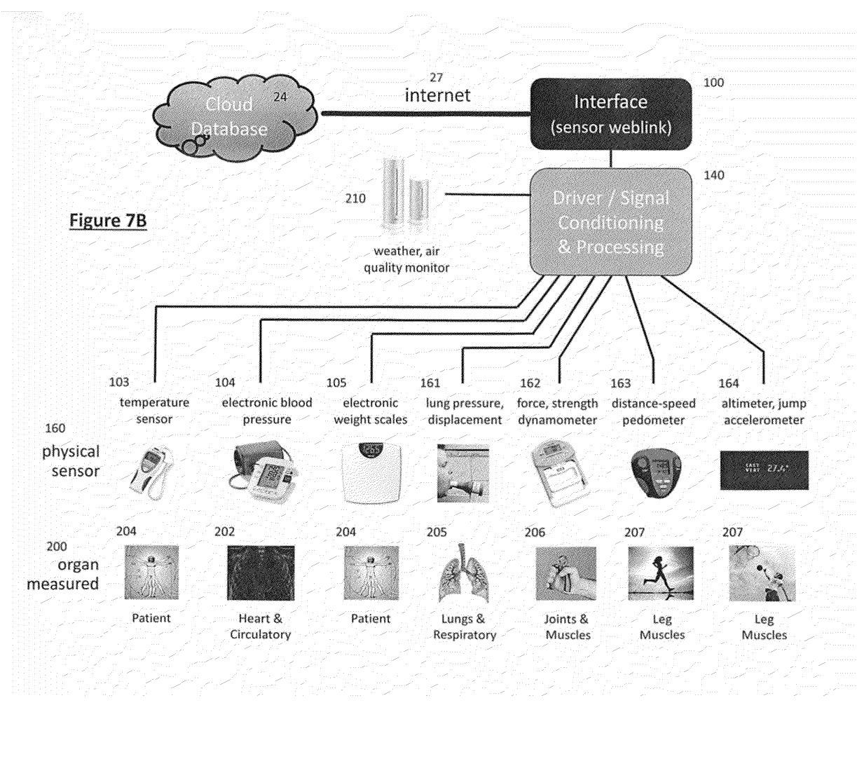

As shown in FIG. 6, electrical sensors, i.e., devices measuring electrical signals, are capable of measuring biometrics for virtually all organs except for bones. FIG. 7A illustrates a few examples of electrical sensors 150 and the organs measured 200.

Brainwave sensor 151, for example, measures EEG (electroencephalogram) signals and the neuron activity in brain 201. The signals can be used to detect a concussion, analyze a sleep disorder, or monitor a migraine headache. Since neural activity is purely electrical in nature, the measurement is directly a measurement of current or voltage. Some tests, such as analyzing sleep disorders can only be measured at home, meaning eCheckup may in some instances be the only practical means to analyze a condition.

The heart also generates electrical ECG (electrocardiogram) signals that permeate the entire body and are easily detectable by a finger sensor 152, monitoring changes in electrical potential or conductivity. Simple analysis can measure the pulse and heat rate, while more complex analysis can reveal heart arrhythmias, murmurs, and other heart disorders signaling the onset of heart disease. Other electrical pulses also monitor neural activity, including the peristaltic activity in the intestines, and in muscles.

Electrical sensors can also monitor the pH and conductance 153 to look for ionic changes in the surface of the skin 203 or in the mouth. As shown in FIG. 6, pH sensors can also be used to evaluate fluid samples, especially for urine, where an acidic pH can be indicative of the onset of a bladder infection.

As shown in FIG. 7B, physical sensors 160 measure physical parameters such as force, pressure, temperature, weight, speed and distance. Some examples include thermometer sensor 103 or electronic weight scales 105, measuring the temperature and weight of patient 204, automated electronic blood pressure cuff 104 used for monitoring the heart and circulatory system 202 for hypertension (or hypotension), lung pressure, displacement monitor 161 for measuring the health of the respiratory system 205, problems in which are often indicative of cardio-vascular disease, and force, strength dynamometer 162 for measuring the health of joints and muscles 206.

Distance-speed pedometer 163 along with altimeter, jump accelerometer 164 can measure the health of leg muscles 207. While these devices cannot necessarily remain connected to the Internet and the eCheckup cloud database during a test or evaluation, their data can be stored and uploaded at a later time when Internet connectivity is available. Another measurement, air quality 210, is not biometric, but it can indirectly monitor lung and respiratory health by evaluating the air we breathe for particulates, pollens, CO₂, CO, ozone, and other noxious or poisonous gases, along with temperature and humidity. Also noted in FIG. 6, physical sensors can also be used to measure tissue elasticity, the ability to stretch and recover without damage.

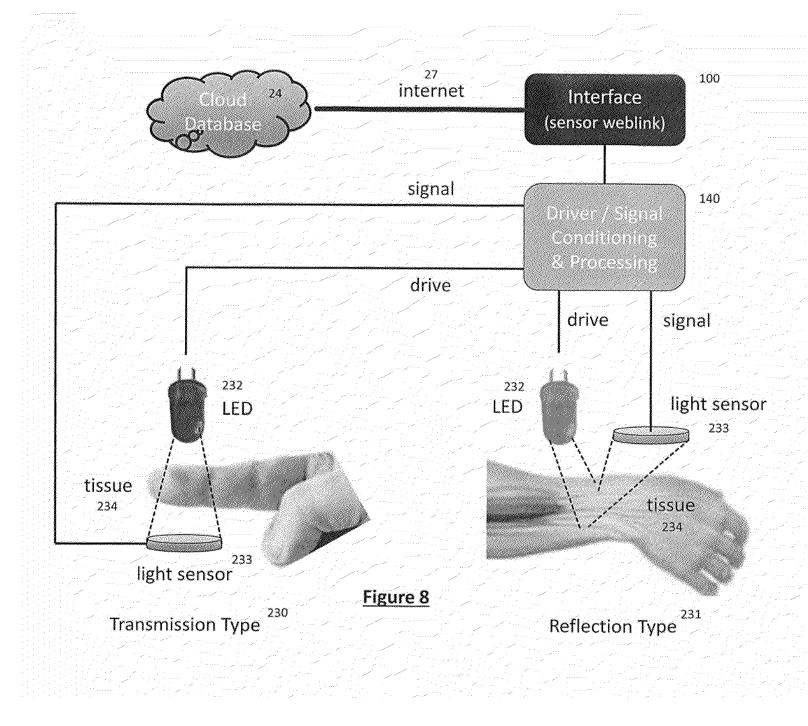

FIG. 8 illustrates that other than in cameras, optical sensors can be realized in two methods—transmission type monitors 230 and reflection type monitors 231. In each case, a particular wavelength of light is emitter from light source 232, typically an LED or laser, and absorbed by a light sensor 233 to analyze properties of any intervening tissue or fluid 234. In transmission type analysis, the light's wavelength must be chosen to pass through tissue 234, while in the reflection type monitor 231 the light does not penetrate the tissue except slightly. For example infrared light penetrates tissue while blue light mostly reflects off skin.

By measuring the signal attenuation at certain wavelengths, the presence or lack of certain gases or chemicals can be inferred. In this manner, oxygen in the blood can be measured directly, as indicated in FIG. 6. Accurate measurement of blood sugar has however been found to be much more difficult to achieve optically without the need for taking a blood sample. Infrared light has also been used to diagnose the presence of melanoma.

For completeness, even though an electronic thermometer was described as an electrical measurement, one of the most common methods for measuring temperature is to use an infrared sensor to measure the spectrum of radiated heat of a person, where this spectrum directly identifies a patient's body temperature.

Cameras represent another class of optical sensor useful for qualitative evaluation of a patient. While not biometric is the strict sense, video images or recordings from a micro-camera allow a physician to see inside a patient's nose, mouth, ears, and to look as eye coloration indicative of infection or jaundice. A nano-camera, once ingested, radios video information as it travels through the stomach and intestinal tract back to a belt worn video recording device, easily uploaded into the eCheckup cloud database.

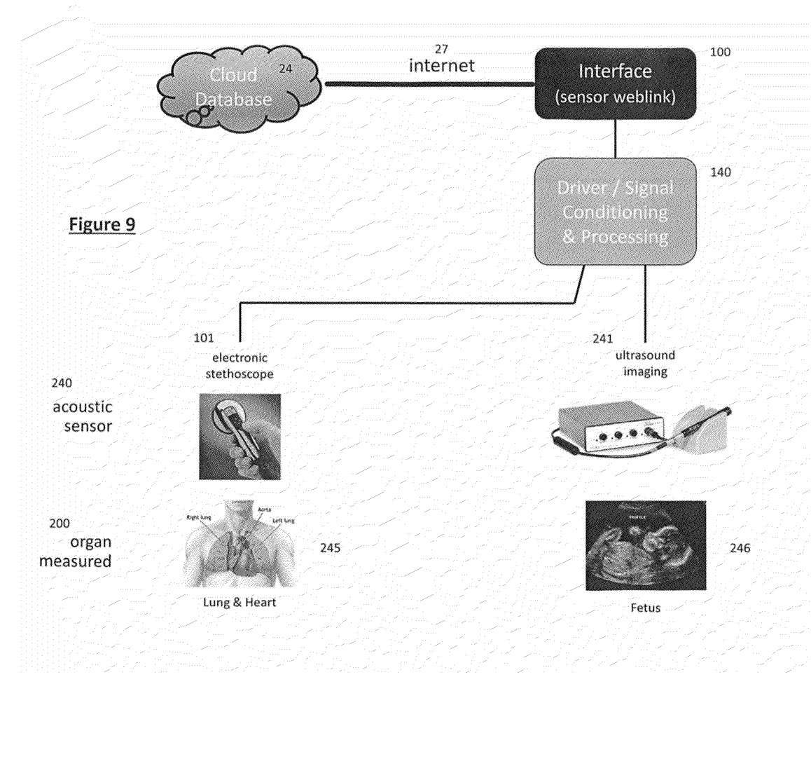

Acoustic sensors 240 shown in FIG. 9 include an electronic stethoscope 101 used for monitoring the lungs and heart 245 and an ultrasound-imaging device 241 useful for monitoring a fetus 246 or possibly for detecting broken bones.

Chemical, biochemical, and bio-organism sensors can be used to measure the presence of extremely low levels of chemicals, organic molecules or pathogens. As indicated in FIG. 6, chemical sensors can be used with blood and urine samples to check for oxygen, salts, water, calcium, potassium, sugars, and carbon dioxide. Biochemical sensors measure organic molecules in urine, including proteins indicative of liver disease or pregnancy. In blood, biochemical sensors can be used to measure hemoglobin, platelets, leukocytes, vitamin D concentrations, and other indicators of HIV. Other tests may comprise analysis of sweat for biochemical indicators of disease. Bio-organism sensors can check blood, urine, tissue ablation biopsies (scratching off skin) and oral swab biopsies for the presence of specific diseases and antigens identifying the likely presence of sexually-transmitted diseases (STDs), bacteria, cancer or pathogens.

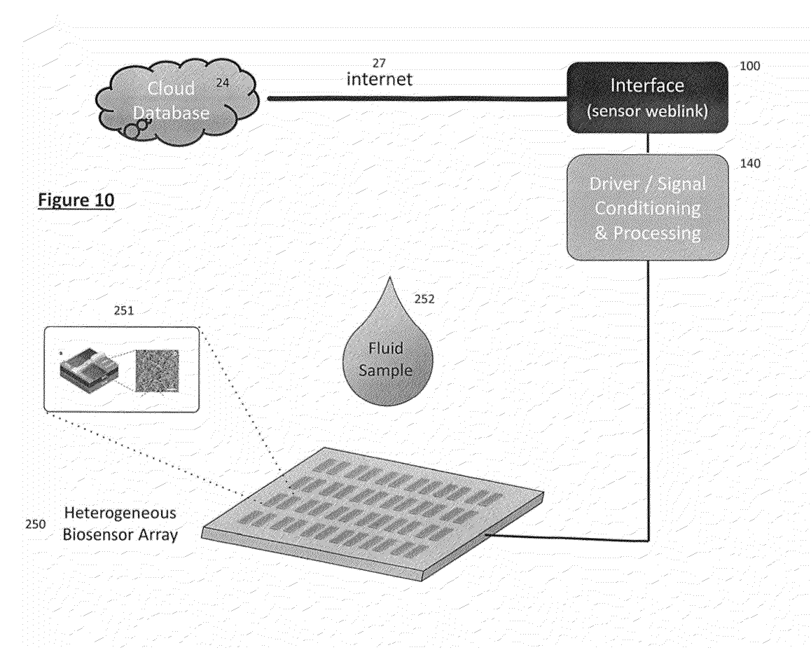

As shown in FIG. 10, chemical, biochemical, and bin-organism sensors may comprise a chip comprising a heterogeneous sensor array 250 to monitor a fluid or tissue sample 252. The array involves various sensors, as shown, for example, by the bin-transistor 251. In some cases, a device coated with a certain antibody will only react with a change of electrical conductivity when the antibody coating detects the presence of a specific antigen invoking an antigen antibody reaction.

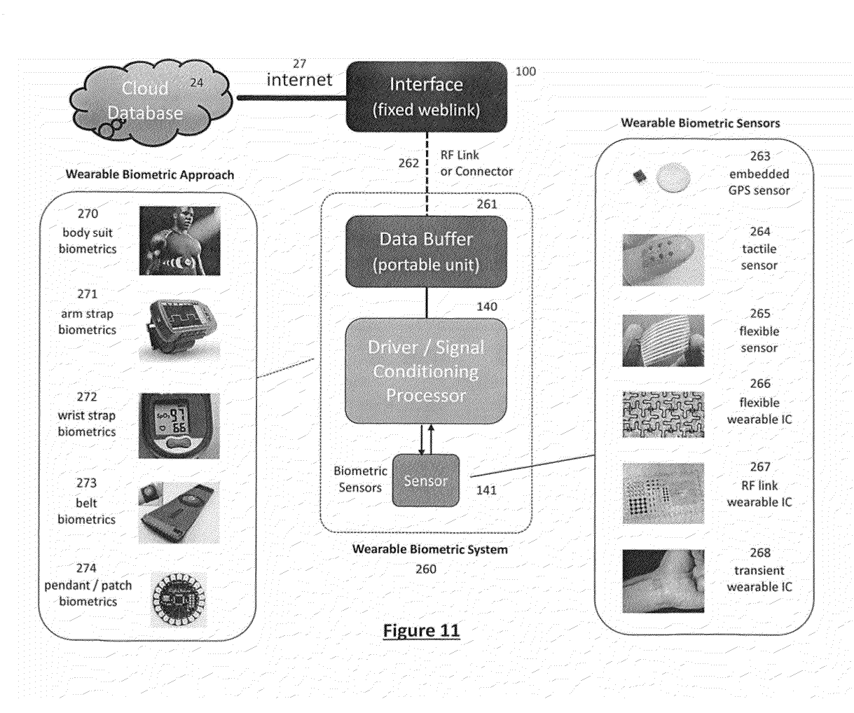

FIG. 11 illustrates a wearable biometric system 260 in conjunction with a variety of physical arrangements such as body suit biometrics 270, arm strap biometrics 271, wrist strap or watch biometrics 272, belt strap biometrics 273, and pendant/patch biometrics 274. Each wearable biometric system 260 comprises a biometric sensor 141, a driver and signal conditioning processor 141, and portable data buffer 261 with an RF link to interface 100. The wearable biometric sensors may, for example, comprise embedded GPS sensor 263, tactile sensor 264, flexible sensor 265, flexible wearable IC 266, RF link wearable IC 267, or transient (dissolvable) wearable IC 268.

In operation, the patient wears wearable biometric system 260 during activity and sensor 141 gathers biometric data continuously or on a sample basis over an extended duration, processing the data in processor 140 and storing the data in buffer 261. When wearable biometric system 260 comes in contact with interface 100, the stored data tile is transferred from data buffer 260 to interface 100 through RF link or connector 262 and the uploaded to the cloud database 24.

The biometric sensor data obtained by the eCheckup methodology disclosed herein may be used for medical purposes or as part of an athletic training program.

1. A method of performing a remote medical checkup of a patient comprising:
transmitting data specifying a test to be performed on the patient from a medical service provider to a cloud database via the internet;
transmitting data relating to the test to be performed on the patient via the internet from the cloud database to a biometric sensor positioned so as to be capable of performing the test on the patient;
transmitting resulting measurement data obtained from the test via the internet from the biometric sensor to the cloud database; and
transmitting the resulting measurement data via the internet from the cloud database to the medical service provider.

2. The method of claim 1 further comprising transmitting data concerning a medical condition or symptom via the internet from the patient to the cloud database.

3. The method of claim 2 wherein transmitting data concerning a medical condition or symptom via the internet from the patient to the cloud database comprises entering the data in a computer.

4. The method of claim 2 further comprising transmitting the data concerning a medical condition or symptom via the internet from the cloud database to the medical service provider.

5. The method of claim 4 comprising storing the data specifying a test to be performed on the patient in a test file in the cloud database.

6. The method of claim 5 further comprising storing in the test file at least one member of the group consisting of patient identity information, patient medical history information, a description of the biometric senor to be used in the test, calibration information relating to the biometric sensor, test measurement setup information, and the resulting measurement data obtained from the test,

7. The method of claim 1 comprising transmitting an email or SMS text reminder to the patient.

8. The method of claim 1 wherein transmitting data relating to the test to be performed from the cloud database to a biometric sensor and transmitting resulting measurement data obtained from the test from the biometric sensor to the cloud database comprise transmitting data via a cell base station

9. The method of claim 8 wherein transmitting data relating to the test to be performed from the cloud database to a biometric sensor and transmitting resulting measurement data obtained from the test from the biometric sensor to the cloud database comprise transmitting data via a mobile phone or a smartphone.

10. The method of claim 9 wherein the biometric sensor is plugged into the mobile phone or smartphone.

11. The method of claim 8 wherein transmitting data relating to the test to be performed from the cloud database to a biometric sensor and transmitting resulting measurement data obtained from the test from the biometric sensor to the cloud database comprise transmitting data via a tablet computer.

12. The method of claim 11 wherein transmitting data relating to the test to be performed from the cloud database to a biometric sensor and transmitting resulting measurement data obtained from the test from the biometric sensor to the cloud database comprise transmitting data between the tablet computer and a wireless biometric sensor via a Bluetooth wireless communications link.

13. The method of claim 1 wherein transmitting data relating to the test to be performed from the cloud database to a biometric sensor and transmitting resulting measurement data obtained from the test from the biometric sensor to the cloud database comprise transmitting data via a wireless modem and a tablet or laptop computer.

14. The method of claim 13 wherein transmitting data relating to the test to be performed from the cloud database to a biometric sensor and transmitting resulting measurement data obtained from the test from the biometric sensor to the cloud database comprise transmitting data via a wireless modem and a tablet computer and transmitting data between the tablet computer and a wireless biometric sensor via a Bluetooth wireless communications link.

15. The method of claim 13 wherein transmitting data relating to the test to be performed from the cloud database to a biometric sensor and transmitting resulting measurement data obtained from the test from the biometric sensor to the cloud database comprise transmitting data via a wireless modem and a laptop computer and transmitting data between the laptop computer and a biometric sensor via a universal serial bus (USB) cable.

16. The method of claim 1 wherein transmitting data relating to the test to be performed from the cloud database to a biometric sensor and transmitting resulting measurement data obtained from the test from the biometric sensor to the cloud database comprise transmitting data via a wired modem.

17. The method of claim 16 wherein transmitting data relating to the test to be performed from the cloud database to a biometric sensor and transmitting resulting measurement data obtained from the test from the biometric sensor to the cloud database comprise transmitting data between the wired modem and an analog biosensor via an wire electrical connector.

18. The method of claim 1 wherein transmitting data relating to the test to be performed on the patient via the internet from the cloud database to a biometric sensor comprises transmitting data used to calibrate the biometric sensor.

19. The method of claim 1 wherein the biometric sensor comprises an electrical sensor.

20. The method of claim 1 wherein the biometric sensor comprises a chemical sensor.

21. The method of claim 1 wherein the biometric sensor comprises a biochemical sensor.

22. The method of claim 1 wherein the biometric sensor comprises a bio-organism sensor.

23. The method of claim 1 wherein the biometric sensor comprises a physical sensor.

24. The method of claim 1 wherein the biometric sensor comprises an optical sensor.

25. The method of claim 1 wherein the biometric sensor comprises an acoustic sensor.
